(19) United States
(12) Patent Application Publication
(10) Pub. No.: US 2009/0288076 A1
(43) Pub. Date: Nov. 19, 2009

(54) Managing Updates In A Virtual File System

(76) Inventors: Mark Rogers Johnson, Glendale, CA (US); Joseph Rice, Berkeley, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/467,186

(22) Filed: May 15, 2009

Related U.S. Application Data
(60) Provisional application No. 61/054,095, filed on May 16, 2008.

(51) Int. Cl. G06F 9/44

(52) U.S. Cl. 717/168

(57) ABSTRACT

Updating a file system in a media player is disclosed. The media player or a portable medium in the media player may have instructions which cause the media player to request an update to a portable medium. The update is composed of multiple update components from an update server. In response to the request, the update server queries content servers for information about the update request. Based on available update information from the content servers, the update server creates a composite manifest file, the composite manifest including a plurality of content updates. The update server digitally signs the composite manifest and sends the composite manifest file, the signature file, and location information for the updates included in the manifest file to the media player. The media player downloads the content updates. The media player and the portable medium may conform to the Blu-ray Disc specifications.

### RELATED APPLICATION INFORMATION

This patent claims priority from Provisional Patent Application No. 61/054,095 filed May 16, 2008, which is incorporated by reference herein in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

1. Field

This disclosure relates to updating files in a virtual file system, particularly virtual file systems associated with media players such as a Blu-ray Disc player.

2. Related Art

The Blu-ray Disc is an optical disc storage medium that is an improvement on the standard digital versatile disc (DVD) format. The Blu-ray Disc enables high-definition video and data storage with up to 50 GB per disc. The Blu-ray Disc has the same physical dimensions as standard DVDs and compact discs (CDs). When compared to a DVD, the Blu-ray Disc offers better video resolution, graphics, and viewer interactivity. In addition, the Blu-ray Disc player provides the ability to get disk content related material over the Internet directly from the player. For example, the Blu-ray Disc can link to updated material on the Internet that was created after the disk was released. This ability provides the user a richer movie or gaming experience.

### DESCRIPTION OF THE DRAWINGS

FIG. 1 is a block diagram of an environment in which updating a file system may be implemented.

FIG. 2 is a conceptual block diagram of a first embodiment of an environment in which updating a file system may be implemented.

FIG. 3 is a flow chart of the actions taken according to a first embodiment of a system for updating a file system.

FIG. 4 is a conceptual block diagram of a second embodiment of an environment in which updating a file system may be implemented.

FIG. 5 is a flow chart of the actions taken according to a second embodiment of a system for updating a file system.

### DETAILED DESCRIPTION

Described herein are a system and method that allows a group of audio/visual and application content updates to be combined dynamically into a single update, such as for downloading from a network server to a local playback device. In particular, described herein are a system and method for dynamically generating a single content manifest that defines the modifications to be made to a file system in the playback device to combine multiple content updates as a single file system update. In addition, described herein are the steps necessary to generate a digital signature of the manifest sufficient to verify the authenticity and integrity of the update, which may be a requirement of the playback device needed to allow the content update.

The technical specification “System Description Blu-ray Disc Read-Only Format: Part 3. Audio Visual Basic Specifications” (the “BD-ROM Specification”) defines an audio visual content format for optical disc. In that specification, the playback device for the optical media may optionally support a virtual file system (VFS) composed of files located both on the optical disc itself and/or files that reside in a local storage area of the playback device itself. The nature of this virtual file system is such that it may be updated with new files and new audio visual content. As a result, the original contents and functionality of the optical disc may be extended through the addition of content, namely, audio and video files, or application files, such as those downloaded from a network server, to this virtual file system. According to the BD-ROM Specification, the contents of the virtual package are specified by a single manifest file. The manifest file describes the mapping of files located on the disc and in local storage to their relative positions and names in the virtual file system. In addition, the BD-ROM Specification defines a signature file to validate the authenticity of the manifest. Once a signature file is generated, any modification or tampering with the manifest will render it invalid. According to the BD-ROM Specification, only one manifest and one signature file may be active at any given time.

Many real-world use cases for content updating require that the user or other dynamic factor be responsible for determining which updatable content is to be installed and made active at any one instant. For example, a common use case considers a scenario in which three items may be available for update: a new movie preview featuring an actor starring in a movie on the disc; a mandatory application update to fix known errors in an original version distributed on the disc; and a new audio commentary to accompany a feature film on the disc. In order for a BD-ROM implementation to allow a user to independently select among the available updates and have them made active at one time, a separate manifest and corresponding signature file must be provided for each allowed combination. However, as the number of update items increases, the number of possible combinations may increase exponentially. The VFS update mechanism defined by the BD-ROM Specification places the burden on the content provider to manage the generation of the manifest and signature files for such scenarios.

The system and method described herein defines a mechanism whereby a multitude of combinations of updates may be managed in an automatic fashion in which each updatable item may be addressed as an independent component that may be assembled with zero or more other updatable components and formed into a single VFS update. According to the system and method described herein, a single VFS update is performed by dynamically generating the necessary manifest file from a combination of individual parts representing the individual updatable components. A digital signature is then generated from the combined manifest to authenticate the contents of the manifest. Such combined manifest and signature files may be generated in an on-demand manner at the time of each update request, or they may be pre-generated and stored in bulk in an automated fashion in order to address all or a large portion of the possible update requests. A caching method can also be implemented in which manifest and signature file pairs are initially generated on-demand, and then stored for use in addressing future requests for the same combination of updates.

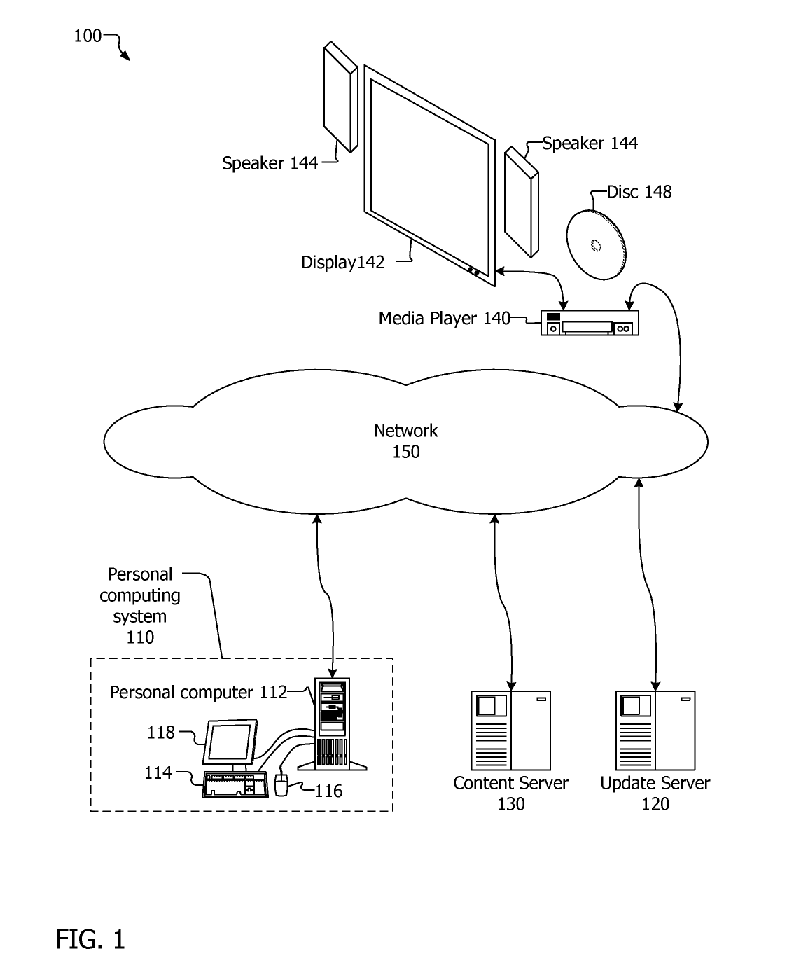

The systems and methods described herein may be implemented in an environment 100 that includes the components shown in FIG. 1, namely a disc or other portable medium playback device, such as BD-ROM playback device shown as media player 140 and as a media player in personal computer 112, a disc 148 or other portable medium, and servers such as update server 120 and content server 130. Although only one each of update server 120 and content server 130 are shown, there may be multiple update servers 120 and content servers 130.

The media player supports the Virtual File System feature set and has the ability to download files from a network server. The media player may be a BD-ROM playback device shown as media player 140, may be included in personal computer 112 of personal computing system 110, may be a cable box or other computing device with a media player included therein or coupled thereto. The media player may be coupled with a display 142 and a network 150. The display may have speakers 144 included therein or coupled thereto. In another embodiment, the media player 140 may be coupled with an audio component such as a surround sound system, not shown, to which the speakers 144 may be coupled. Although only two speakers are shown, the system may have more speakers. Similarly, although only one display is shown, some embodiments may have multiple displays. Display 142 may be a high definition video monitor that conforms to a well-known standard, such as, for example, 1080p. The display may be one of a variety of available technologies, including, for example, LCD, plasma, and projection.

The personal computing system 110 may include a personal computer 112, user input devices such as a keyboard 114, mouse 116, track ball, pen and tablet, and others, a display 118, as well as a media player, such as, for example, a BD-ROM playback device. The personal computer also includes a network interface card or network interface chip or chipset and related software that allows for communication over the network 150. Other components may be included in or coupled with the personal computer 112 to make up personal computing system 110.

The disc 148 may be a BD-ROM disc or other disc that may be read or played by the player 140 and personal computer 112 that includes a BD-ROM player. The disc 148 contains a fixed set of audio visual content and applications designed to operate within media player 140 and personal computer 112 that includes a media player. Although shown as disc 148, the systems and methods described herein may be applicable to other portable media that have fixed content stored thereon, such as, for example, storage cartridges that include memory; memory or media cartridges, cards or sticks; flash memory devices; and other portable media that may be inserted into media players to be viewed on a display and heard from speakers or otherwise execute by a player.

The network 150 may be the Internet. The network 150 may be a local area network (LAN), a wide area network (WAN), a storage area network (SAN), or a combination of these. The network 150 may be wired, wireless, or a combination of these. The network 150 may be comprised of numerous nodes providing numerous physical and logical paths for data units to travel. Each node may be a computing device as described below. Communications on the network 150 may take various forms, including frames, cells, datagrams, packets, messages, streams, higher level logical groupings, or other units of information, all of which may be referred to as data units.

The content server 130 stores multiple sets of files containing content intended for extending the fixed content provided on discs such as disc 148. Although one content server is shown, there may be multiple content servers. As used herein, the term content refers to computer files that may be used to enhance or improve the fixed content on disc 148 or other media in a media player 140. As used herein, the term content includes, but is not limited to, graphics files, video files, multimedia files, audio files, HTML files, software applets or applications, software application updates, and others.

The update server 120 may store an update server application (“USA”) that responses to the update client application and prepares a manifest of content intended for extending the fixed content provided on media such as, for example, disc 148.

In one embodiment, disc 148 also has stored thereon an update client application (“UCA”). The update client application places update requests that may be serviced by the update server application (“USA”) on update server 120 or an update generator that may be executed by a media player. The update client application may communicate with the update server application on update server 120 or the locally executed update generator to download content files from one or more content servers 130. The downloaded content files may be stored on local storage media included in or coupled with the media player.

The media player 140, personal computer 112, update server 120 and content server 130 are all considered computing devices. A computing device may include software and/or hardware for providing all or part of the functionality and features described herein. A computing device may include one or more of logic arrays, memories, analog circuits, digital circuits, software, firmware, and processors such as microprocessors, field programmable gate arrays (FPGAs), application specific integrated circuits (ASICs), read-only memory (ROMs), electronically erasable programmable read-only memory (PROMs), programmable logic devices (PLDs) and programmable logic arrays (PLAs). The computing devices described herein all include a network interface card or network interface chip or chipset and related software that allows for communication over the network 150. The hardware and firmware components of the computing devices may include various specialized units, circuits, software and interfaces for providing the functionality and features described here. The processes, functionality and features may be embodied in whole or in part in software which operates on a computing device and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by a computing device and others by other devices coupled with or included in the computing device.

A computing device as used herein includes a processor, memory and a storage device that may execute instructions including, but not limited to, personal computers, server computers, computing tablets, set-top boxes, cable boxes, video game systems, personal video recorders, video players including Blu-ray Disc players, telephones, personal digital assistants (PDAs), portable computers, and laptop computers. These computing devices may run an operating system, including, for example, variations of the Linux, Unix, MS-DOS, Microsoft Windows, Palm OS, Solaris, Symbian, and Apple Mac OS X operating systems.

The techniques described herein may be implemented by specialized software. The specialized software may include an update client application and either an update generator or a update server application, depending on the embodiment. The update client application may be stored on a portable medium, such as a BD-ROM disc or other disc such as disc 148, in a media player such as player 140, namely in a ROM, FPGA or other PLD or other storage media included in the player 140, or other storage media which may be in a storage device included with or otherwise coupled or attached to a computing device such as personal computing system 110. In one embodiment, the update generator may be stored on a portable medium such as a BD-ROM disc or other disc such as disc 148 or may be stored in a ROM, FPGA or other PLD or other storage media included in a media player, such as, for example, a BD-ROM playback device.

As used herein, the terms media and storage media include, for example, magnetic media such as hard disks, floppy disks and tape; optical media such as compact disks (CD-ROM, CD-RW, BD-ROM) and digital versatile disks (DVD and DVD±RW); flash memory cards; storage cartridges that include memory; media cartridges, cards or sticks; and other storage media. A portable medium is a version of a storage medium that may be easily carried and transported by a human user of the portable medium. As used herein, a storage device is a device that allows for reading and/or writing to a storage medium. Storage devices include hard disk drives, Blu-ray disc players, DVD players, personal video recorders, flash memory readers, and others.

The update server application may be included in or otherwise stored on storage media included in, coupled with or otherwise accessible by the update server 120. The update server application may access a database stored on the update server 120 and one or more content servers 130. The database describes each of several sets of content such as audio-visual or application files that may each be treated as an independent update component. The database may conform to a well known format or be proprietary, so long as an interface is provided for access by the update server application. The database may be a simple table, be relational, be a structured query language (SQL) database, may be a Java Database and may be accessible via Open Database Connectivity (ODBC) or Java Database Connectivity (JDBC). Each database or file that identifies an update component may include some or all of the following information:

a. An unique identifier for each update component by which each component may be requested;

b. A list of source file locations pertaining to each update component describing the location from which the files may be downloaded;

c. A list of destination file locations pertaining to each update component describing the location in the media player's local storage to which to download the source files;

d. A list of file mappings to the virtual file system in the media player 140 corresponding to the portable media, such as disc 148, for example, a BD-ROM optical disc;

e. Optionally, additional information about each update component such as the total size of the component, a date at which the update component may be made available, a date at which the update component may expire, and others. Further, the additional information about the content may include the date of release, type of content (music, movie, game, advertisement, etc.), name of the source or provider of the content, and metadata that may include information such as genre (drama, action, musical, heavy metal, alternative, children's, adult, etc.), rating (MPAA and ESRB ratings, for example), key persons (such as, for example, names of musicians and actors in the content) and key characteristics (such as, for example, ESRB content descriptors), and the like;

f. Optionally, additional information regarding any pre-existing or previously downloaded update components associated with the specific media player 140 or the specific portable medium, such as disc 148; and

g. Optionally, additional information regarding one or more individual users of the media player 140 who may each have different combinations of update components that they have requested.

In one embodiment, the update server application on the update server 120 may be or include an application program referred to as an “update generator”. In another embodiment, the update generator may execute on the media player. The update server application and/or the update generator may have the following capabilities:

a. The ability to receive a request for one or more individual update components;

b. The ability to dynamically form a manifest file that describes the specific update components requested for a specific media player 140;

c. The ability to digitally sign the resulting manifest file in a manner that may be used to validate the integrity and authenticity of the manifest;

d. Optionally, the ability to include in the manifest any previously requested update components such as to ensure that the resulting update does not cause the loss of prior updates;

e. Optionally, the ability to include in the manifest any update components that may have been previously requested by other users such as to avoid loss of prior updates requested by these other users;

Additional and fewer units, modules or other arrangement of software, hardware and data structures may be used to achieve the processes and apparatuses described herein.

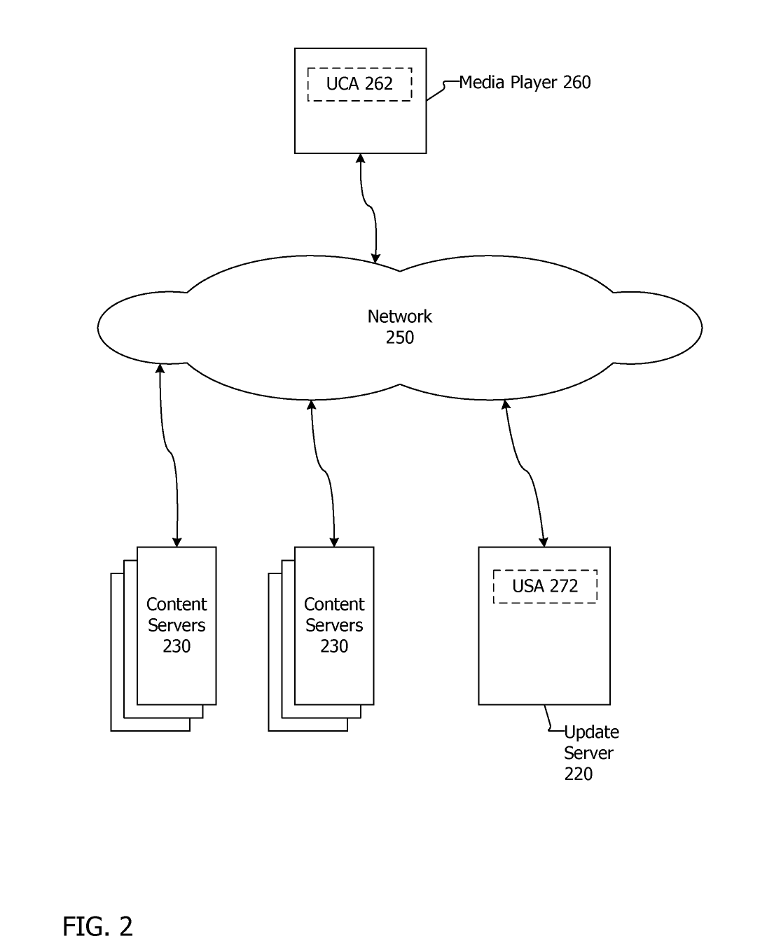

FIG. 2 is a conceptual block diagram of a first embodiment of an environment in which updating a file system may be implemented. In this embodiment, the media player 260 executes an update client application 262 which may be provided on a portable medium, such as, for example, a BD-ROM or other disc. The update client application 262 communicates over the network 250 with an update server 220 running an update server application 272 to extend and/or enhance the media included on a portable medium played in the media player 260. The update server 220 obtains additional content to extend and/or enhance the content included on the portable medium by obtaining additional content from content servers 230.

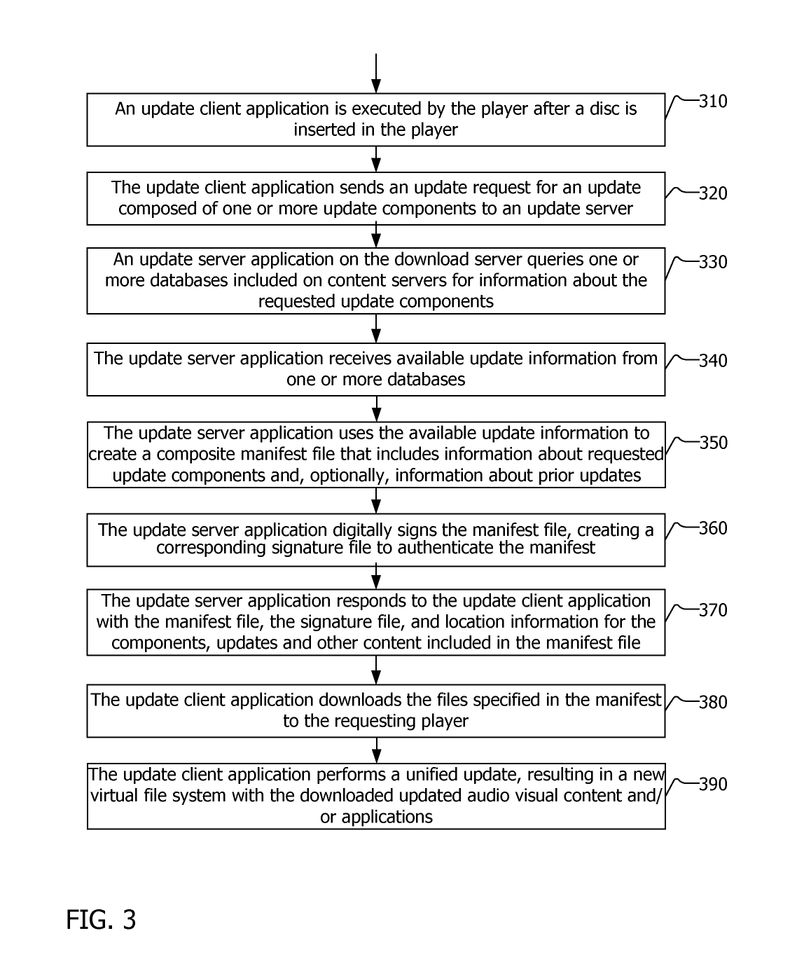

In the environment described regarding FIG. 2, the following actions shown in FIG. 3 may be taken to achieve the managing of updates in a virtual file system. FIG. 3 is a flow chart of the actions taken according to a first embodiment of a system for updating a file system.

When a portable medium is placed in a media player, such as when a disc is placed in a BD-ROM playback device, for example, when the disc 148 is in the media player 140 or a disc or other portable medium is placed in a set-top box or personal computer, the update client application is executed by the media player, for example, a BD-ROM player, a set-top box or a personal computer, as shown in block 310. The update client application sends an update request for an update composed of one or more update components to an update server application that includes or is an update generator, as shown in block 320. The request may include a portable medium identifier. The portable medium identifier is a number or alphanumeric string that uniquely identifies the portable medium, and is typically provided on the portable medium by the manufacturer. The request may also include a media player identifier and/or an update history from the media player. The media player identifier is a number or alphanumeric string that uniquely identifies the media player, and is typically provided in the media player by the manufacturer. The update server application is software that runs on an update server, such as update servers 120 and 220 shown in FIGS. 1 and 2.

The update server application then, using the portable medium identifier, queries one or more local and/or remote databases included on content servers for information about the requested update components, including source and destination file locations and VFS file mappings, as shown in block 330. Optionally, the update server application may query a local database for information about previously installed update components for the current player.

The update server application receives available update information from one or more databases, which may include a local database as well as databases on remote content servers, as shown in block 340. The update server application uses the available update information received from the one or more databases on one or more content servers to create a composite manifest file, as shown in block 350. The composite manifest file includes information about all of the requested update components (that is, the available update information) and, optionally, update information about prior updates, as shown in block 350. The composite manifest file includes various information about the updates obtained from the databases on the content servers (described above), destination locations for the updates on the destination media player, and, optionally, additional information obtained from the databases on the content servers (described above).

The update server may limit the updates provided to the requesting update client application and included in the composite manifest file based on the media player identifier based on the update history of the media player which may be maintained by the update server application. The update server may limit the updates provided to the requesting update client application and included in the composite manifest file based on the media player update history provided by the update client application.

The format of the manifest file may conform to a well known standard that is also supported by the media player. In one embodiment the manifest confirms to the Blu-ray Disc Specification. In this embodiment, the manifest is an XML file format with a Blu-ray Disc Specification schema. In this embodiment, the manifest includes a section that defines a one-to-one mapping of files stored in the player's local storage to locations within the virtual file system. This includes ensuring that each of the multiple updates are mapped to different locations in the VFS.

The update server application digitally signs the manifest file, creating a corresponding signature file to authenticate the manifest, as shown in block 360. In one embodiment, the signature file contains an RSA signature that is generated and encoded as described by Internet Engineering Task Force (IETF) Request for Comment (RFC) 2313. In this embodiment, a signature value included in the signature file is generated using a private key that corresponds to the Binding Unit Root Certificate that is delivered on the BD-ROM disc, as described in the BD-ROM Specification. In other embodiments, the signature file may be created using a private key using a signing algorithm for which a public key is available for the player to verify the signature. This may be achieved using an RSA algorithm or other technique. Other authentication schemes may be used to create the signature.

The update server application responds to the update client application with the manifest file, signature file, and location information for the each of the components, updates and other content specified in the manifest file to be included in the download, as shown in block 370. The file location information may be a uniform resource locator (URL), or other file location identifier used to obtain files from a server over the Internet or other network, from attached storage, or from the portable medium itself.

The update client application downloads the files specified in the manifest to the requesting player, including verifying the signature of the downloaded files, as shown in block 380. The update client application performs a unified update, resulting in a new virtual file system with the downloaded updated audio visual content and/or applications, as shown in block 390. This may be achieved by the update client application issuing a request to the local device to perform a virtual file system update. The virtual file system update request includes the location on the device where the manifest and signature files are stored. In response, the media player reads the manifest file from the specified location, validates it with the signature file, and proceeds to map files into the virtual file system according to the manifest, which causes the local copies of the content update files to be made on the device.

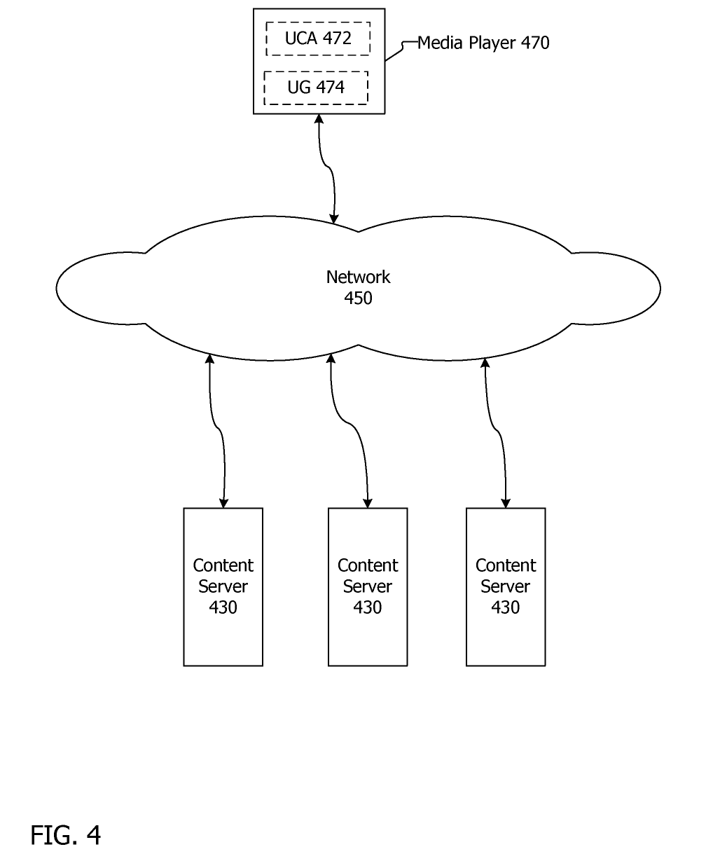

FIG. 4 is a conceptual block diagram of a second embodiment of an environment in which updating a file system may be implemented. The media player 470 executes an update client application 472 which may be provided on a portable medium, such as, for example, a BD-ROM disc. In this embodiment, the player 472 also executes an update generator 474. The update generator 474 may be software that may be provided on a portable medium, such as a BD-ROM or other disc, or may be included in a storage device included in or coupled with the media player 470, such as a ROM, PROM, EEPROM, FPGA, or other PLD, as well as flash memory or a hard disk drive. The update client application 472 communicates with the update generator 474 to extend and/or enhance the media included on the portable medium in the media player 470. The update generator 474 obtains additional content to extend and/or enhance the content included on the portable medium by obtaining additional content over network 450 from content servers 430. Although three content servers are shown, one, two and more than three content servers may be included in the system and method.

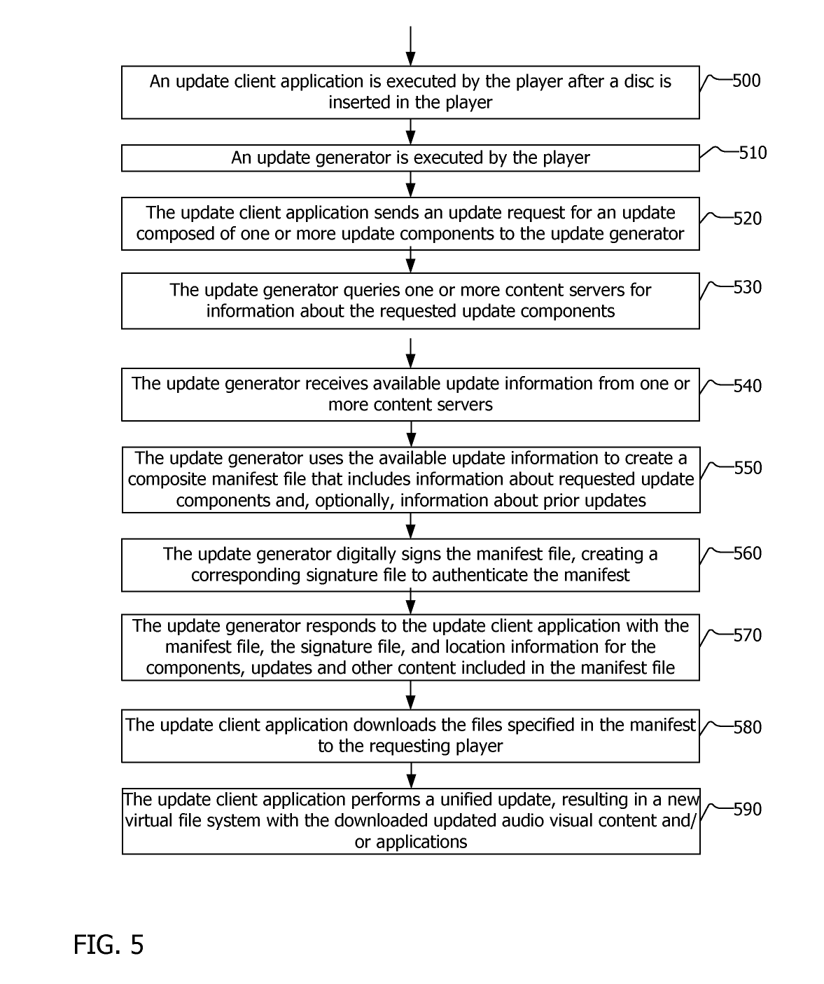

In the environment described regarding FIG. 4, the following actions shown in FIG. 5 may be taken to achieve the managing of updates in a virtual file system (“VFS”). FIG. 5 is a flow chart of the actions taken according to a second embodiment of a system for updating a file system.

When a portable medium is placed in a media player, such as when a disc is placed in a BD-ROM playback device or player, for example, when the disc 148 is in the media player 140 (shown in FIG. 1) or a disc or other portable medium is placed in a set-top box or personal computer 112 (shown in FIG. 1), the update client application is executed by the player, as shown in block 500. An update generator is then executed by the media player, such as a BD-ROM playback device or other media player, as shown in block 510. The update generator may be provided on a portable medium, such as a BD-ROM or other disc, or may be included in a storage device included in or coupled with the media player, such as a ROM, PROM, EEPROM, FPGA, or other PLD, as well as flash memory or a hard disk drive. The update client application sends an update request for an update composed of one or more update components to the update generator, as shown in block 520. The request may include a portable medium identifier. The portable medium identifier is a number or alphanumeric string that uniquely identifies the portable medium, and is typically provided on the portable medium by the manufacturer. The request may also include a media player identifier and/or an update history from the media player. The media player identifier is a number or alphanumeric string that uniquely identifies the media player, and is typically provided in the media player by the manufacturer.

The update generator then, using the portable medium identifier, queries one or more local and/or remote databases included on content servers for information about the requested update components, including source and destination file locations and VFS file mappings, as shown in block 530. Optionally, the update generator may query a local database on the player or a local file system for information about previously installed update components for the current player.

The update generator receives available update information from one or more content servers, as shown in block 540. The update generator uses the available update information received from the one or more content servers to create a composite manifest file, as shown in block 550. The composite manifest file includes information about all of the requested update components (that is, the available update information) and, optionally, update information about prior updates, as shown in block 550. The composite manifest file includes various information about the updates obtained from the databases on the content servers (described above), destination locations for the updates on the destination media player, and, optionally, additional information obtained from the databases on the content servers (described above).

The update generator may limit the updates provided to the requesting update client application and included in the composite manifest file based on the media player identifier based on the update history of the media player which may be maintained by the update generator. The update generator may limit the updates provided to the requesting update client application and included in the composite manifest file based on the media player update history provided by the update client application.

The format of the manifest file may conform to a well known standard that is also supported by the media player. In one embodiment the manifest conforms to the Blu-ray Disc Specification. In this embodiment, the manifest is an XML file format with a Blu-ray Disc Specification schema. In this embodiment, the manifest includes a section that defines a one-to-one mapping of files stored in the player's local storage to locations within the virtual file system. This includes ensuring that each of the multiple updates are mapped to different locations in the VFS.

The update generator digitally signs the manifest file, creating a corresponding signature file to authenticate the manifest, as shown in block 560. In one embodiment, the signature file contains an RSA signature that is generated and encoded as described by Internet Engineering Task Force (IETF) Request for Comment RFC 2313. In this embodiment, a signature value included in the signature file is generated using a private key that corresponds to the Binding Unit Root Certificate that is delivered on the BD-ROM disc, as described in the BD-ROM specification. In other embodiments, the signature file may be created using a private key using a signing algorithm for which a public key is available for verifying the signature. This may be achieved using an RSA algorithm or other technique. Other authentication schemes may be used to create the signature.

The update generator responds to the update client application with the manifest file, the signature file, and file location information for each of the components, updates and other content specified in the manifest file to be included in the download, as shown in block 570. The file location information may be a URL or other file location identifier used to obtain files from a server over the Internet or other network, from attached storage, or from the disc itself.

The update client application downloads the files specified in the manifest to the requesting player, including verifying the signature of the downloaded files, as shown in block 580. The update client application performs a unified update, resulting in a new virtual file system with the downloaded updated audio visual content and/or applications, as shown in block 590. This may be achieved by the update client application issuing a request to the local device to perform a virtual file system update. The virtual file system update request includes the location on the device where the manifest and signature files are stored. In response, the media player reads the manifest file from the specified location, validates it with the signature file, and proceeds to map files into the virtual file system according to the manifest which causes the local copies of the content update files to be made on the device.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A media player having instructions stored in a storage medium included in the media player which when executed cause the media player to perform actions comprising:
receiving a portable medium;
executing an update client application included on a portable medium inserted in the media player;
the update client application
sending an update request for an update composed of one or more update components from an update server, the update request including a portable medium identifier;
receiving from the update server a manifest file, a signature file, and location information for a plurality of content updates included in the manifest file;
downloading the plurality of content updates to the media player, thus updating a file system on the media player.

2. The media player of claim 1 wherein the update request further includes at least one of an update history and a media player identifier.

3. The media player of claim 1 further comprising:
executing a content update included in the plurality of content updates.

4. The media player of claim 1 wherein the media player is a Blu-ray Disc playback device and the portable medium is a Blu-ray Disc.

5. A media player having instructions stored in a storage medium included in the media player which when executed cause the media player to perform actions comprising:
receiving a portable medium;
executing an update client application included on the storage medium included in the media player;
the update client application
sending an update request for an update composed of one or more update components from an update server, the update request including a portable medium identifier;
receiving from the update server a manifest file, a signature file, and location information for a plurality of content updates included in the manifest file;
downloading the plurality of content updates to the media player, thus updating a file system on the media player.

6. The media player of claim 5 wherein the update request further includes at least one of an update history and a media player identifier.

7. The media player of claim 5 further comprising:
executing a content update included in the plurality of content updates.

8. The media player of claim 5 wherein the media player is a Blu-ray Disc playback device and the portable medium is a Blu-ray Disc.

9. A portable medium having instructions stored thereon which when executed cause a media player to perform actions comprising:
executing an update client application included on the portable medium;
the update client application
sending an update request for an update composed of one or more update components from an update server, the update request including a portable medium identifier;
receiving from the update server a manifest file, a signature file, and location information for a plurality of content updates included in the manifest file;
downloading the plurality of content updates to the media player, thus updating a file system on the media player.

10. The portable medium of claim 9 wherein the update request further includes at least one of an update history and a media player identifier.

11. The portable medium of claim 9 wherein the media player is a Blu-ray Disc playback device and the portable medium is a Blu-ray Disc.

12. A method in an update server, the method comprising:
receiving an update request for an update composed of one or more update components from a media player, the update request including a portable medium identifier;
querying at least one content server for information about the update request;
receiving available update information from at least one content server, the available update information including location information for available updates;
creating a composite manifest file based on the available update information, the composite manifest including a plurality of content updates;
digitally signing the composite manifest file to create a signature file;
sending the composite manifest file, the signature file, and the location information for available updates included in the composite manifest file to the media player.

13. The method of claim 12 wherein the digitally signing is performed according to Internet Engineering Task Force (IETF) Request for Comment RFC 2313.

14. The method of claim 12 wherein the format of the composite manifest conforms to the Blu-ray Disc standards.

15. A portable medium having instructions stored thereon which when executed by a media player cause the media player to perform actions comprising:
executing an update generator;
executing an update client application
the update generator
receiving an update request for an update composed of one or more update components from a media player, the update request including a portable medium identifier;
querying at least one content server for information about the update request;
receiving available update information from at least one content server, the available update information including location information for available updates;
creating a composite manifest file based on the available update information, the composite manifest including a plurality of content updates;
digitally signing the composite manifest file to create a signature file;
sending the composite manifest file, the signature file, and the location information for available updates included in the composite manifest file to the update client application.

16. The portable medium of claim 15 wherein the digitally signing is performed according to Internet Engineering Task Force (IETF) Request for Comment (RFC) 2313.

17. The portable medium of claim 15 wherein the format of the composite manifest conforms to the Blu-ray Disc standards, wherein the media player is a Blu-ray Disc player, and wherein the portable medium is a Blue-ray Disc.
